(19) United States
(12) Patent Application Publication
(10) Pub. No.: US 2004/0236647 A1
(43) Pub. Date: Nov. 25, 2004

(54) Electronic checkbook register

(76) Inventor: Ravi Acharya, Philadelphia, PA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/443,879

(22) Filed: May 23, 2003

(51) Int. Cl. G06F 17/60

(52) U.S. Cl. 705/30

(57) ABSTRACT

An electronic checkbook register is provided. The electronic checkbook register comprises a checkbook operatively connected to a display, one or more input devices, and a processor. The processor is programmed to receive financial data input from a user at the one or more input devices, process the financial data, output processed financial data to the display device, and synch the financial data with account information stored at a remote banking computer. The input devices can include a touch-sensitive pad beneath the checks and/or a pen detector or built-in optical sensor configured to detect a user's handwriting and pass the handwriting information to the processor. The processor can store financial information in a memory module operatively connected to the processor. Further provided is a system, method, and computer-readable medium for operating the above-described invention.

### FIELD OF THE INVENTION

The present invention is generally related to checkbooks, and more particularly, to an electronic checkbook register.

### BACKGROUND OF THE INVENTION

People write checks as legal tender to pay for goods and services. People keep records of these financial transactions in order to manage their finances and plan personal budgets. In particular, people consult with their bank to determine the most up-to-date balance of their checking account in order to determine the amount of funds available for future checks. A user's current account balance depends on all the transactions actually posted to a user's account. Because checks take time to clear and post to a user's account, the current account balance is often different from the funds effectively available to a user after all outstanding checks have cleared, which can be referred to as the effective account balance. Most banks that provide accounts assess charges or sanctions if a user's account balance drops below zero; however, there is no penalty for writing checks in an amount greater than the current account balance, provided sufficient funds are added to the balance before any outstanding checks clear. For this and a variety of other reasons, users desire to know both their current checking account balance and their effective checkbook balance after all outstanding checks have cleared.

For tracking checking account balances, the prior art includes traditional checkbooks and personal financial manager tools like Quicken® and Microsoft® Money software programs, which provide account balance information and are available on personal computers (PCs) as well as portable personal digital assistants (PDAs).

However, the prior art checkbook and personal financial management software systems have several disadvantages. First, traditional paper checkbooks, including those with included calculators, require the user to manually record transactions and calculate effective balances. While the checkbook can provide a good estimate of available funds, it does not by itself disclose to the user which transactions have cleared through the bank, i.e., it does not disclose the current account balance. Further, mathematical errors are more likely to occur because, even with the help of a calculator, the user has to manually enter and calculate balances and records. Finally, it does not interface with a bank and therefore cannot provide an official current account balance to the user at the time when the user writes a check. These are all significant disadvantages.

Personal digital assistants (PDAs) can offer beneficial applications to this problem. They can store records and, when properly programmed, automatically calculate balances based on user inputs. For example, PDAs that include personal financial manager (PFM) software programs such as Quicken® and Microsoft® Money can be used to manage a user's financial information, including current bank account information and outstanding checks. PDAs can also receive and record alphanumeric user inputs, including financial information such as amounts of outstanding checks.

However, the PDA approach has significant drawbacks. The user must enter the check information into the PDA, unless the PDA is used with additional peripheral devices to write and print the check onto special check stock. Such peripheral devices cannot be easily transported to point-of-sale locations where consumers traditionally write checks. Further, as known in the art, PDAs do not record a picture of a handwritten check. Although PDAs can temporarily store user handwriting, primarily for the purpose of converting an individual handwritten character into its corresponding alphanumeric symbol, PDAs do not store a comprehensive picture of a single document written by the user, such as a check. In conventional PDAs the user handwriting information is lost when PDAs separately convert each character of the user's handwriting to alphanumeric data, which has a smaller file size and is more amenable to processing on spreadsheets. Also, the user typically writes each handwritten character over the last one in a small input area, rather than writing successive letters and numbers in a row from left to right.

Further, although a PDA can be used together with a traditional checkbook to manage account information, the two objects are separate and distinct rather than operatively linked. Thus, two separate objects are required to achieve the two functions of check-writing and synching with official bank information. The computer programs used by PDAs must be used in conjunction with a checkbook or other system for producing physical checks. There currently is no apparatus that combines the functions of these programs with an actual checkbook. Some tech-savvy consumers have opted to move all of their checking needs onto a strictly-digital forum such as online banking and bill payment, but consumers nevertheless continue to write billions of paper checks each year.

As an alternative to PDAs, personal computers can have similar Quicken® or Microsoft® Money software, and they further have peripheral devices that allow for scanning and recording pictures of handwritten checks or other handwritten information. Handwriting recognition software can enable personal computers to convert the writing on checks into alphanumeric text. However, the additional peripheral devices necessary to accomplish these goals are not easily portable. Additionally, there does not appear to be any apparatus currently available that can scan a check, convert it into alphanumeric text, and integrate the text into PFM functionality.

In sum, neither PDAs nor personal computers provide any system for writing or printing checks of legal tender. Finally, although Quicken®, Money, and other programs for personal computers and PDAs allow for automated account management functions, they do not capture the official account information until a check clears through a bank.

### BRIEF SUMMARY OF THE INVENTION

Accordingly, some or all of the deficiencies outlined above are overcome by providing in one exemplary embodiment an electronic checkbook register including a checkbook, an electronic display device coupled to the checkbook, a user input, and a processor. The processor is adapted to receive financial data input by the user, process the financial data, and output the processed financial data to the display device. The processor can be additionally adapted to synchronize the financial data with account information stored at a remote banking computer.

According to another aspect of the invention, a system for managing an electronic checkbook register and one or more deposit accounts is provided which includes: an electronic checkbook register with a processor operatively connected to a checkbook, a display, an input device for receiving check information from a user, and a memory storing account information; a remote computer having a memory storing account information; and a communications network between the electronic checkbook register and the remote computer for transmitting the register's stored account information to the remote computer or the remote computer's account information to the register.

According to another aspect of the invention, a method for processing user financial information is provided which provides: receiving user input from an input device operatively connected to a processor, wherein the user input is user writing including a payee or an amount of money on a check operatively connected to a processor and a display device; processing the user input; calculating user-specific financial information based on the input, wherein the user-specific financial information comprises at least one of a current balance, an available balance, and a balance after pending check or payment account transactions have cleared; and storing the user-specific financial information in a memory operatively connected to the processor. The method can further include receiving updated account information from a remote banking computer and processing the updated account information.

According to another aspect of the invention, a computer readable medium encoded with computer program code to manage an electronic checkbook register is provided, wherein the program code is effective to: receive user input from an input device operatively connected to a processor, wherein the user input comprises user writing including a payee or an amount of money on a check operatively connected to a processor and a display device; process the user input; calculate user-specific financial information based on the user input, wherein the user-specific financial information is a current balance, an available balance, and/or a balance after pending checking account transactions have cleared; and store the user-specific financial information in a memory operatively connected to the processor.

Other embodiments could be considered.

It would be desirable to provide an easily portable device that incorporates a physical checkbook with the functions of financial management software, allows a user to record check information as the checks are written, and allows the user to synchronize current account balance information from the user's bank with new account information from one or more newly-written checks.

It would be further desirable to provide an electronic checkbook register that further records a picture of a user's handwritten check.

It would be further desirable to provide an electronic checkbook register that automatically converts a user's handwritten check into digital alphanumeric text, and that records the information written on the check.

It would be further desirable to provide a system of an electronic checkbook register and remote banking terminals that allows for check-writing, recording, and synchronizing functions.

### DESCRIPTION OF THE DRAWINGS

FIG. 1 is an electronic checkbook register in the open position according to one embodiment of the invention.

FIG. 2 is an electronic checkbook register in the closed position according to an embodiment of the invention.

FIG. 3 is an electronic checkbook register in the closed position according to an embodiment of the invention.

FIG. 4 is an electronic checkbook register in the closed position according to an embodiment of the invention.

FIG. 5 is an electronic checkbook register in the closed position according to an embodiment of the invention.

FIGS. 6, 7, 8A, and 8B are exemplary primary display outputs according to yet another embodiment of the invention.

FIGS. 9A and 9B are exemplary secondary display outputs according to yet another embodiment of the invention.

FIG. 10 is a block diagram showing how the electronic checkbook register may be connected via a communications network to a remote banking computer and/or to a personal computer according to yet another embodiment of the invention.

FIG. 11 is a flow chart of a method for managing account information according to yet another embodiment of the invention.

Before any embodiment of the invention is explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

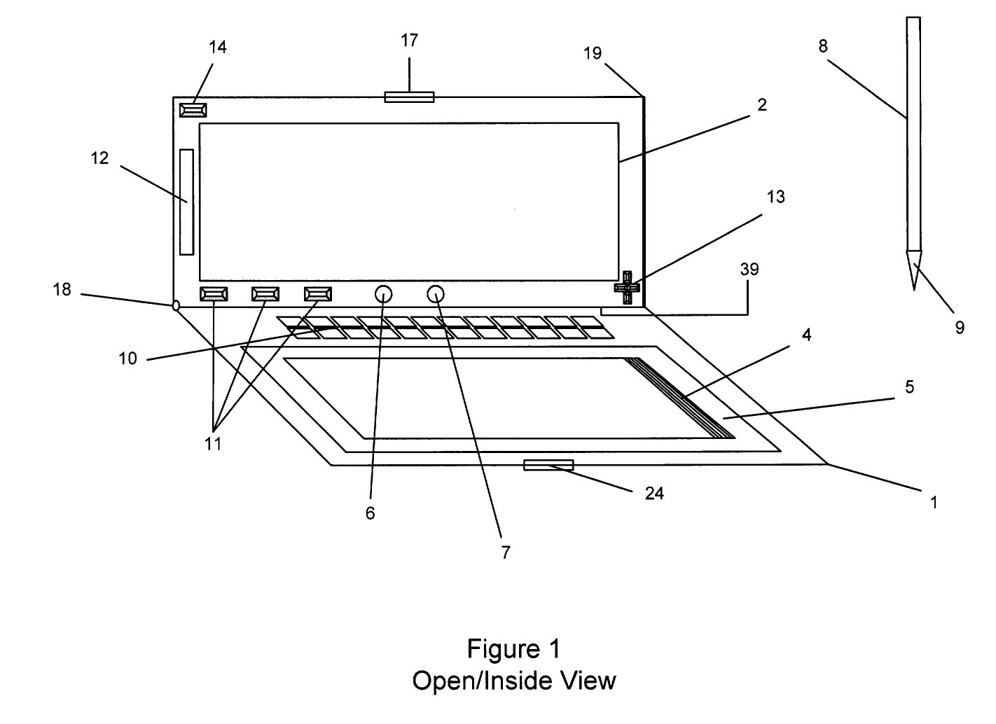

FIGS. 1-5 illustrate different views of an electronic checkbook register according to the present invention. FIG. 1 shows the inside view of an electronic checkbook register 1 according to one embodiment of the invention. The electronic checkbook register 1 may comprise a primary display 2; checks 4; touch-sensitive pad 5; optical reader 6; pen detector 7; pen/stylus 8 with writing tip 9; alphanumeric keypad 10; function buttons 11; display scrollbar 12; hot synch button 14; open/close latch 17, 24; and built-in antenna 19.

As shown in FIG. 1, the electronic checkbook register 1 has a similar form factor to a traditional checkbook. Like a checkbook, the electronic checkbook register 1 has two pieces operatively attached at a hinge 39 that joins the two pieces together. The top piece rotates around the axis of the hinge 39 in relation to the bottom piece. The top piece may include the primary display 2 and a plurality of user inputs 11, 12, and 13. The bottom piece may include the checks 4 and a plurality of user inputs 10.

According to one embodiment of the invention, user inputs 11-13 may comprise function buttons 11; display scrollbar 12; and cursor keys 13. According to one embodiment of the invention, user input 10 may comprise alphanumeric keypad 10.

The electronic checkbook register 1 can be latched closed using the open/close latches 17, 24. In one embodiment, the register 1 will automatically latch closed when the latch 17 on the top piece comes in contact with the latch 24 on the bottom piece. When the register 1 is in the closed position, it can be opened by simultaneously sliding the open/close latch 17, 24 and rotating the top piece away from the bottom piece about a hinge 39, in an action similar to that of opening a traditional checkbook. Any latch mechanism can be considered.

According to one embodiment, the electronic checkbook register 1 includes one or more user input devices, including but not limited to an alphanumeric keypad 10 for entering letters and numbers, a display scrollbar 12 for scrolling through display options and outputs, a synch button 14 for on-demand synchronization of financial information between the electronic checkbook register 1 and a remote computer, and cursor keys 13 for navigating through different screen windows or display fields or for moving a cursor.

Pressing the synch button 14 causes the register 1 to synchronize financial data with a remote computer, such as a remote banking server or a personal computer. Synchronizing data can include updating one set of data on one device, such as the register, by receiving a related set of data from another device, such as a remote server. Synchronizing may also comprise other types of communication involving the transfer of data from one device to another device that processes and stores the data. In a preferred embodiment, the synch button causes the register 1 to request financial information from a remote computer, and in response the remote computer transmits financial information to the register 1. The financial information may comprise information relating to one or more user accounts. The communicated data may be encrypted, and the communication process may further comprise encrypting and decrypting the information.

Function buttons 11 can be used for similar input functions, and also for selecting different power modes, display formats, security settings, and synchronization options for synchronizing information stored at the register 1 with financial information at the user's bank or on the user's personal computer.

These inputs 10-14 can be located anywhere on the register 1. It will be appreciated that inputs 10-14 may be used for any of the input functions discussed above, and their functions may be customized by the user in a preferred embodiment of the invention.

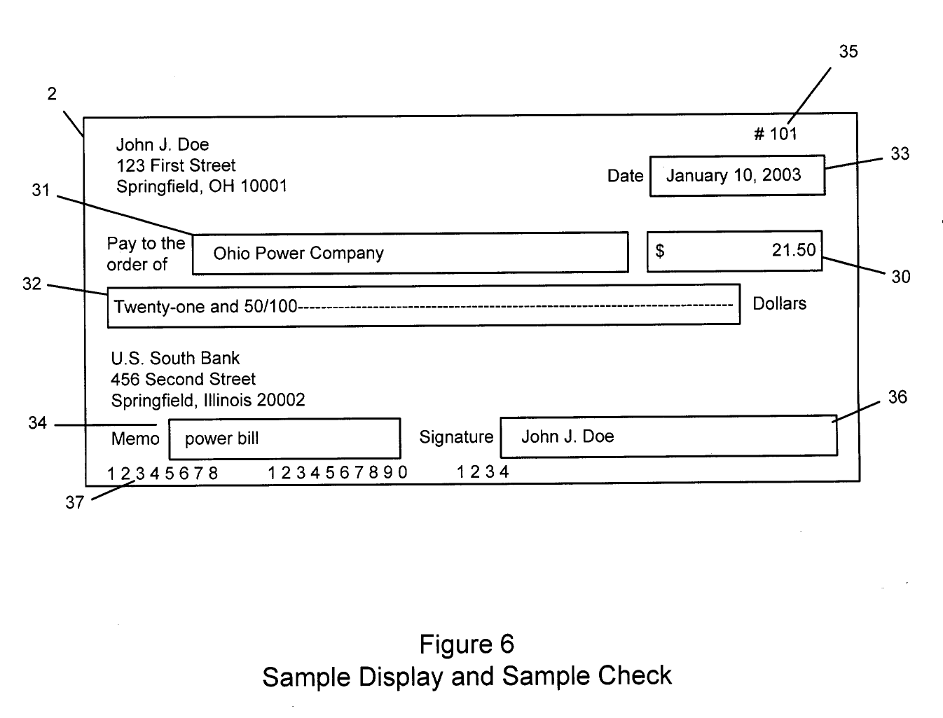

The electronic checkbook register 1 has at least one input device for capturing check 4 information. In one embodiment, the checks 4 rest atop a touch-sensitive pad 5 underneath and flush with the checks 4. As with a traditional checkbook, a user writes on a check 4 using a pen/stylus 8 and fills in the check fields (shown further in FIG. 6). When the user writes on the check 4, pressure from the writing tip 9 is exerted on the touch-sensitive pad 5. The touch-sensitive pad 5 detects the pressure on the check and thereby captures information regarding the writing on the check. Depending on the number and thickness of the checks and also the technology and sensitivity of the touch-sensitive pad 5, a plurality of checks can rest atop the pad and still allow for the pad 5 to detect pressure from the writing on the top check 4. According to a preferred approach, the pen/stylus 8 fits inside a pen/stylus holder 18 on the inside of the electronic checkbook register 1. The pen/stylus holder 18 could instead be located elsewhere on the register 1 that allows for convenient and effective storage of the pen/stylus 8.

Touch-sensitive pad 5 can be implemented according to various well-known technologies, such as the Smart Display by Microsoft Corp. and the TouchPad™ by Synaptics Incorporated.

In another embodiment of the invention, an optical reader 6 records a picture of the written check. For example, the optical reader could operate like a camera, or it could employ another type of technology, such as laser technology, to detect and capture the writing on the checks 4.

Optical reader 6 can be implemented according to various well-known software and hardware technologies, such as LaserFiche Quick Fields™ and the LaserFiche Zone OCR Plug-In™, both by LaserFiche Document Imaging.

In yet another embodiment, a detector 7 detects the writing of the pen/stylus 8. The pen/stylus could be any pen configured to record what is written by the pen, such as the io™ pen by Logitech International S.A. These types of pens can require a special type of paper for the checks 4, and they may additionally require a plurality of pen detectors 7 on various parts of the electronic checkbook apparatus 1 or pen 8. Such pens 8 allow for capturing an image of the written check 4, which can be displayed on the primary display 2 (discussed further in FIG. 6) and stored at the register 1.

According to one approach, the checks 4, stylus/pen 8, and writing tip 9 could use special technology, such as special paper and special ink, to improve the ability of the touch-sensitive pad 5 and/or optical reader 6 and/or pen detector 7 to capture the image of the check 4 and/or the writing on the check 4, such as the writing in the various check fields.

The pen detector 7, the optical reader 6, and the touch-sensitive pad 5 reflect embodiments that allow for capturing an image of the written check and/or the writing on the check. The register 1 preferably includes a single such mechanism for capturing the check image, although multiple such mechanisms could be used to enhance the robustness of register 1. It should be appreciated that such mechanisms can be used to capture any kind of writing, including writing by any traditional writing utensil as well as paper-less writing by electronic means, such as the writing by a stylus on a Palm Pilot, as well as other digital and electronic writing means known in the art.

In another embodiment, there is no input apparatus that automatically captures an image of the check. Instead, the user writes checks and then manually records them as in a typical checkbook with register 1. According to this approach, the user records the check 4 information by entering the information at a user inputs 10, 11, 12, or 13, such as at the alphanumeric keypad 10, and the information is processed and stored in the register 1. The register can then process stored check information with new check information to calculate current balances and other personal financial information.

Preferably, the electronic checkbook register 1 can communicate financial data with other computers. According to this approach, the register 1 may include a built-in antenna 19 for transmitting and receiving wireless signals that can carry financial data. The antenna 19 may be an external antenna or another type of receiver and/or transmitter device. In this way, financial information can be communicated between the register 1, remote banking servers, personal computers, and other devices.

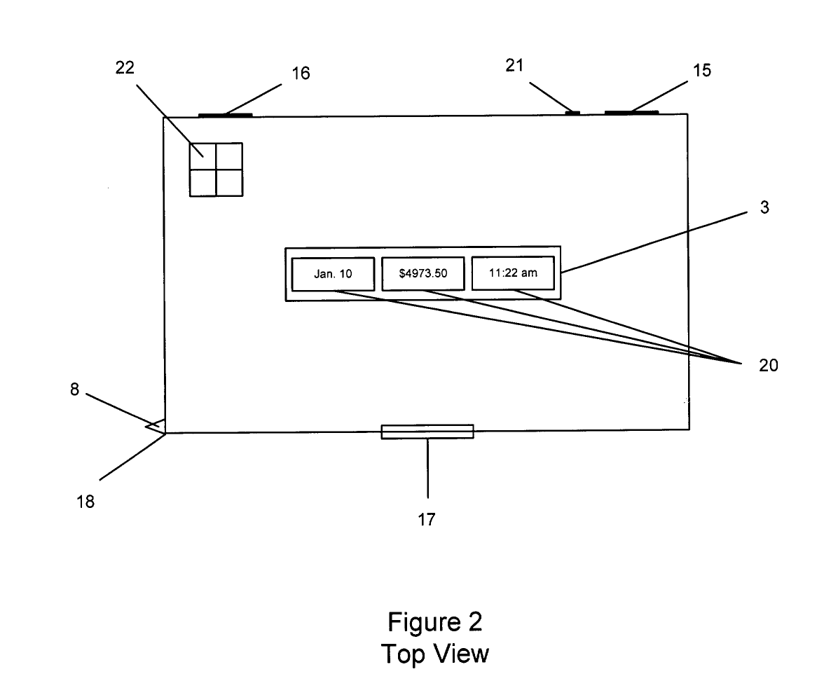

FIG. 2 shows the top view of the register 1 according to an embodiment of the invention. The top of the register 1 may comprise a secondary display 3, a pen/stylus 8, a memory card slot 15, a plurality of ports 16, and a pen/stylus holder 18. It should be appreciated that each of these elements could instead be located on any other side of the register 1.

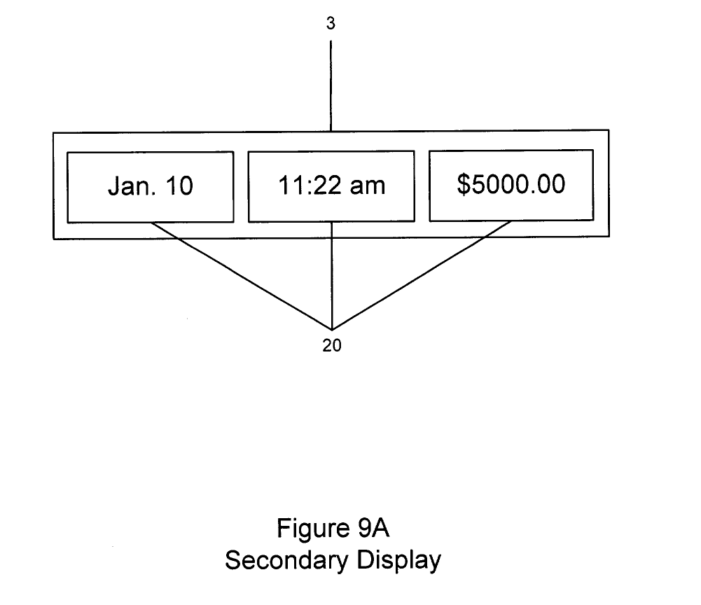

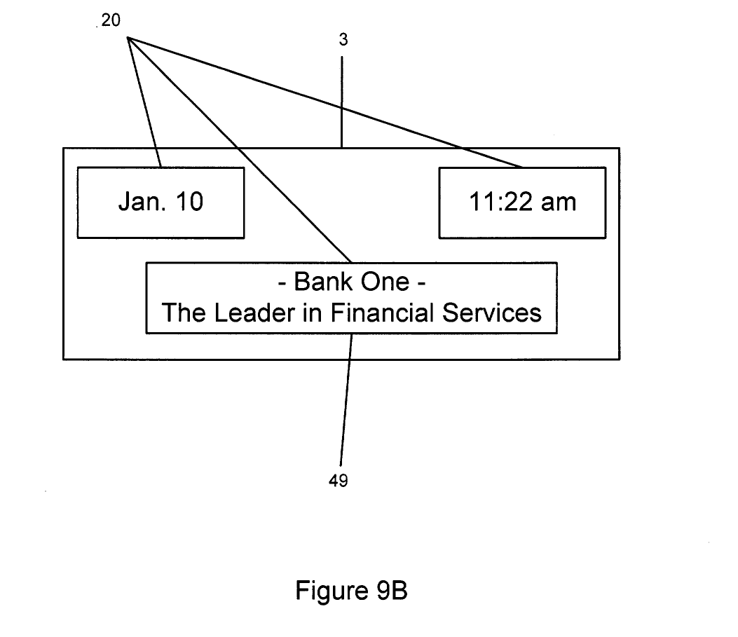

The secondary display 3 can display selected display fields 20 such as time, date, and balance after pending checks have posted to the account (further shown in FIG. 9A). In one embodiment, the register 1 can obtain its power from solar cells 22 on the top of the register 1. The solar cells could be located on any surface of the register 1 that could be exposed to light.

It should be noted that many of the physical elements described herein may be placed in a location different from the locations described above. In particular, the buttons 10, 11, 12, 13, and 14, antenna 19, pen/stylus holder 18, solar cells 22, secondary display 3, memory card slot 15, memory card 25, and ports 16 can be anywhere on the register 1 that is consistent with the position of the checks 4 and the primary display 2. For instance, the memory card 25 need not be on the back of the register 1, but could instead be on the front or side of the register 1.

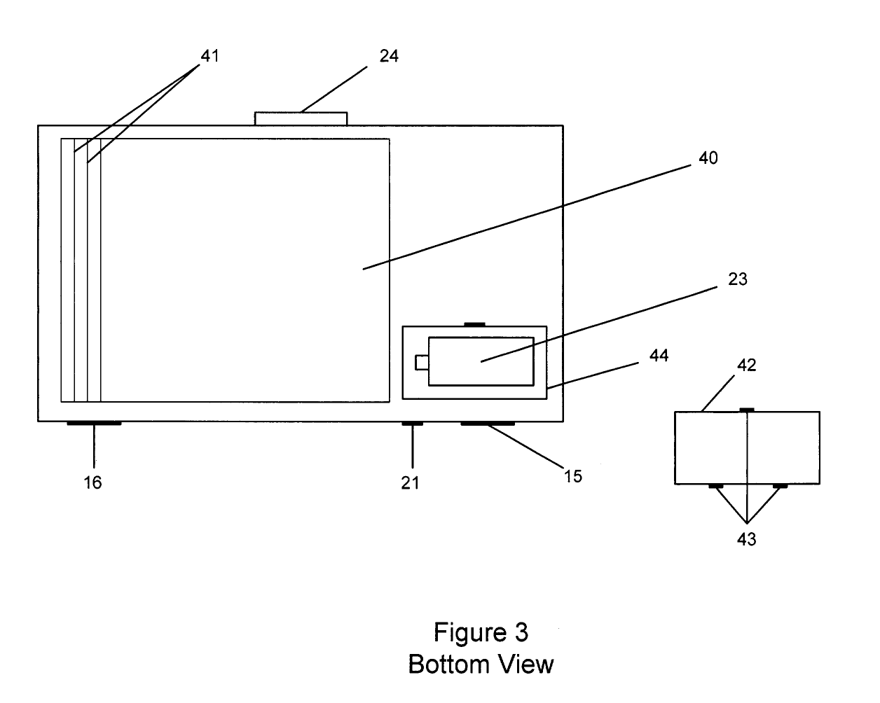

FIG. 3 shows a bottom view of an electronic checkbook register 1 in the closed position according to an embodiment of the invention. The bottom of the register 1 may comprise a memory card slot 15, ports 16, an open/close latch 24, an AC power input 21, a card sleeve 40 containing cards 41, and a battery 23. The battery cover 42 may comprise notches 43 or tabs 43 to affix the cover 42 securely in the battery bay 44 that houses the battery 23 in the register 1. In a preferred embodiment, the electronic checkbook register may derive power from either an AC input 21 or a battery 23. The battery may be rechargeable through a built-in re-charger powered by an AC power source connected to the AC power input 21, and/or solar cells 22 (see FIG. 2). Other recharging apparatus and methods can be considered, such as external re-chargers. The card sleeve 40 can contain various types of cards. In one embodiment, the card sleeve 40 can contain a user's financial cards 41, such as credit cards, debit cards, stored-value cards, and other financial-related cards. The user can access the electronic checkbook register's 1 account information to help the user determine which checking account, card account, or other account to use for a given transaction.

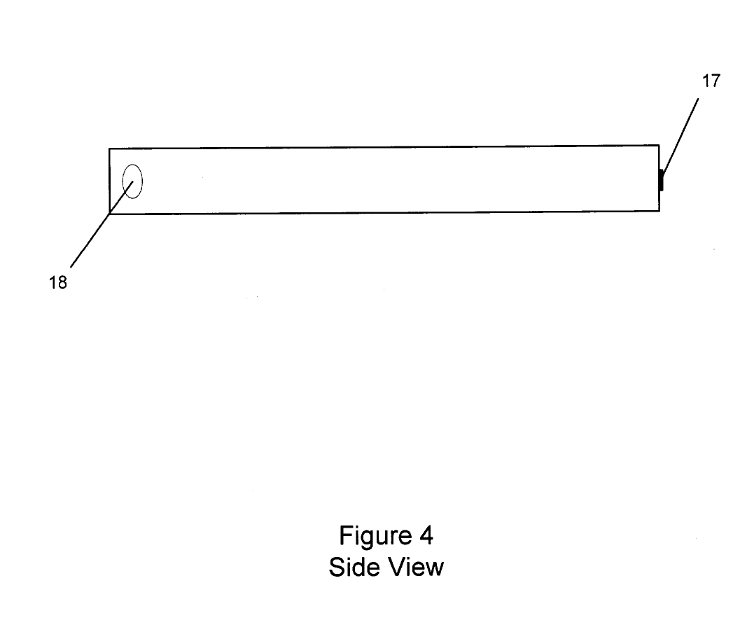

FIG. 4 shows a side view of an electronic checkbook register 1 in the closed position according to an embodiment of the invention. The side of the register may comprise a stylus holder 18 which can hold the stylus 8 and an open/close latch 17, 24.

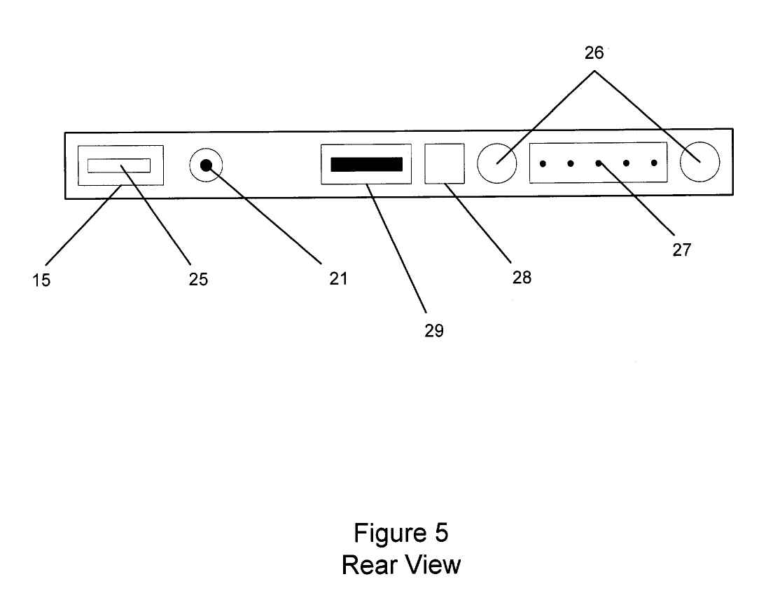

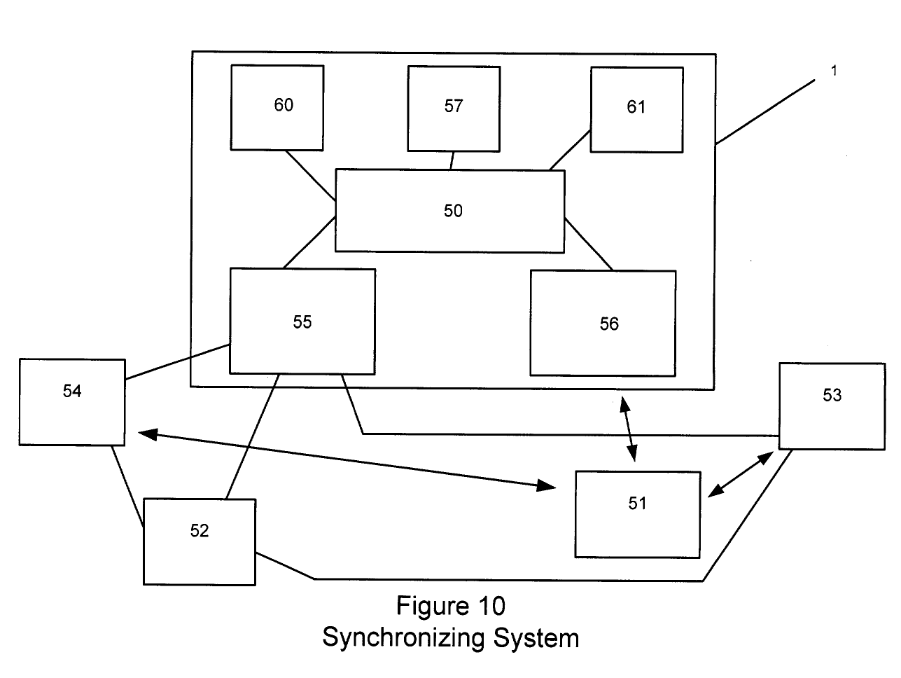

FIG. 5 shows a rear view of the electronic checkbook register 1 in the closed position according to an embodiment of the invention. The rear of the register 1 may comprise additional ports 26-29, such as a USB port 29, a serial port 27, and other ports 26 such as firewire ports, which may allow for electronic communication through direct hook-ups or through connection to other wireless or wired communication devices; such types of communication are well-known in the art. The rear may also comprise a memory card slot 15 which houses a memory card 25. The memory card 25 is preferably detachable from the register 1, allowing for a plurality of different memory cards 25 to be used in the register 1. Examples of detachable memory cards that could be used in the register 1 are Compact Flash® cards and xD-Picture Cards™ by Olympus. The register 1 may also preferably contains a flash memory module, such as flash ROM, that is built-in to the register 1 and operatively connected to a processor, such as the processor of FIG. 10.

FIG. 6 is an exemplary captured image of a handwritten check displayed on the primary display 2 according to an embodiment of the invention. As shown in the image, the check fields can comprise numeric dollar field 30, payee 31, printed dollar field 32, date 33, memo 34, check number 35, signature 36, and routing and account numbers 37. As discussed previously in regard to FIG. 1, the captured information may be captured through an input device such as touch pad 5, optical reader 6, detector 7, or other means for capturing image and/or writing information known in the art. Future technologies for capturing check information could be employed without departing from the spirit and scope of the present invention. Through the use of handwriting recognition technology well known in the art, the electronic checkbook register 1 can process and convert the handwriting to its corresponding alphanumeric symbols, preferably in a form amenable to computer data processing.

It will be appreciated that it may not be necessary to capture the image of an entire check since specific fields contain information relevant to account and balance information and record-keeping. For example, some of the information, such as the check routing and account numbers 37, will be the same for each check and need not be captured and/or recorded separately for each check. It will be further appreciated that the captured image may or may not be displayed. In fact, it may be more practical to display only the alphanumeric text converted from the user's original handwriting.

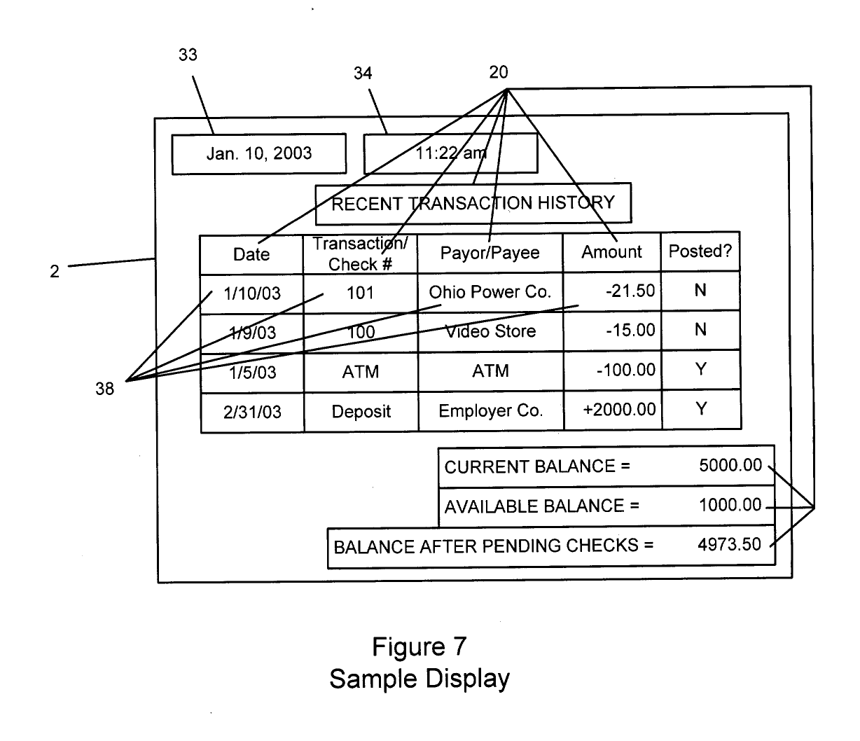

FIG. 7 shows a primary display 2 presents exemplary processed financial information of a user according to one embodiment of the invention. The display may comprise display fields 20, the current date 33, the current time 34, and information from the current check 38. In the example of FIG. 7, the current check field 38 shows that the most recently written check is check #101 in the amount of $21.50. The display fields 20 may show additional information about this check as well as other checks and transactions, such as deposits and ATM transactions. Information relating to deposits, ATM transactions, and any other transactions or information that could post to the user's bank account could be communicated from the user's bank and displayed here.

In this exemplary embodiment, the display shows the date 33, time 34, and a recent transaction history/summary, which shows the past several banking transactions, the current balance of the account, balance of funds available for immediate withdrawal, and the balance after pending checks have cleared. Information for these fields can be processed from check information, user input, and financial information communicated from the user's bank. The user can configure the register 1 to display various desired fields, and in one exemplary embodiment the user can additionally configure the format of the display 2 or 3. For instance, the current balance could be displayed at the top left of the primary display 2 rather than near the bottom right of the display 2. Also, the user could decide to show additional recent transactions and delete the available balance field 20 for the user's preferred display configuration.

The display scrollbar 12 (shown in FIG. 1) can be used to scroll through the information shown in the display. For instance, scrolling downward in FIG. 7 might allow the user to view transactions from the month prior to the current month. User input buttons 12, 10, 11, 13, and 14 allow the user to shift between different views and functions, such as between the check view of FIG. 6 and the exemplary transaction view of FIG. 7.

If the register 1 is enabled to use handwriting recognition technology, the display 2 can show the deciphered printed text corresponding to what was scribed on the check. The current check field 38 of FIG. 7 demonstrates how the primary display 2 can show the printed text of a check, including the date, check number, payee, and amount. The user could then examine this information and make any corrections as necessary by entering the corrections at the user inputs 10, 11, 12, or 13. In one embodiment, this process could be similar to editing a text document on a traditional computer, and any similar methods could be employed.

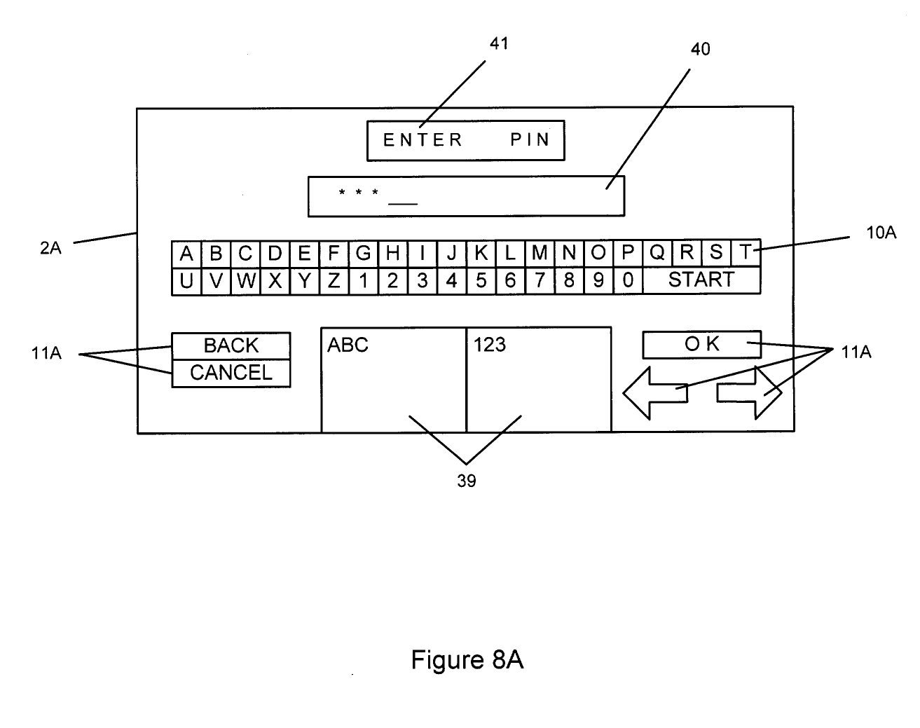

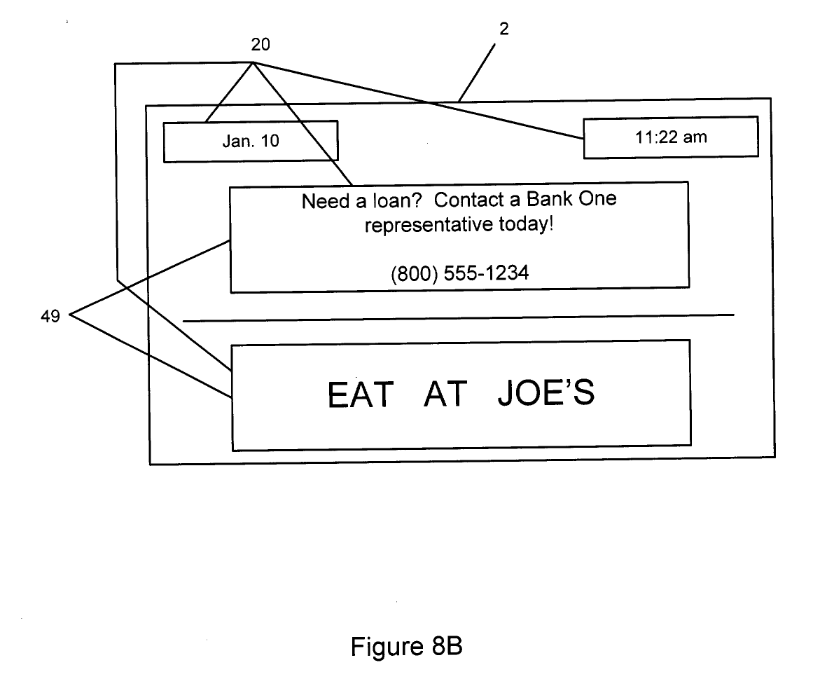

FIG. 8A is an embodiment of the primary display 2 where the primary display 2 is a touch-sensitive display 2A. Two examples of such a display are the displays found on the Compaq Tablet PC and Palm Pilots such as the Palm Tungsten™ C. Information can be entered by touching the screen, either in addition to or instead of using user inputs 10, 11, 12, or 13. The user can touch the screen with the tip 9 of a stylus 8, or with another object such as the user's finger. The capabilities of touch-screens such as the Palm Tungsten™ C and Tablet PC are well-known in the art, and all such devices can be incorporated into the touch-sensitive primary display 2A. For example, the touch-sensitive primary display 2A can allow users to handwrite alphanumeric information in the handwriting recognition fields 39. Through technology well-known in the art, such as the Graffiti® technology used in the Palm Tungsten™ C, the electronic checkbook register 1 can decipher the user's handwriting into alphanumeric symbols, which can then be displayed on the display 2A. Alternately, or in addition, the display 2A can also allow users to enter alphanumeric information by touching the appropriate symbols on a touch-sensitive alphanumeric keypad 10A displayed on the display 2A. Other touch-sensitive inputs 11A can be used for entering information. Any combination of the display 2A inputs 10A, 11A and the other inputs 10, 11, 12, 13 can be used to navigate through on-screen menus and otherwise control the operation of electronic checkbook register 1.

FIG. 8B is another exemplary primary display 2 output according to another embodiment of the invention. This exemplary display 2 comprises display fields 20 and marketing information 49 such as advertisements.

FIGS. 9A and 9B are exemplary secondary display 3 outputs according to yet another embodiment of the invention. FIG. 9A shows a secondary display 3 that is displaying display fields 20 such as the current time, date, and account balance. The displayed account information can be for any account, including a checking account, savings account, and stored value account. Additionally, information from several different accounts can be displayed at any given time in the different display fields 20. FIG. 9B shows a secondary display 3 that is displaying marketing information 49, such as advertisements, and also display fields 20 such as the current time and date. The display fields 20 on both the primary 2 and secondary 3 display may also show such information as the user's name or nickname, a personalized greeting message, an announcement, a task, a to-do list, or any other type of information commonly displayed on personal organizers such as Palm Pilots.

The user may browse to any available display 2, 3 formats, such as the exemplary screens of FIGS. 8 and 9, from any other screen of display 2 and display 3, respectively, by selecting the appropriate user inputs, as shown in FIG. 1. The user may also use the inputs of FIG. 1 to customize which specific display fields 20 are shown at a given time or circumstance, as well as the format of the display fields 20, according to the user's preferences. For instance, the user may select to view a summary of transactions as shown in FIG. 7 whenever the user selects a particular input such as the hot synch button 14 shown in FIG. 1.

It should be appreciated that the displays 2, 3 may be configured to display any type of image or text, including a screen saver display employed to minimize power consumption.

FIG. 10 is a block diagram showing how an electronic checkbook register may be connected via a communications network to a remote banking computer and/or to a personal computer according to yet another embodiment of the invention. The system may comprise an electronic checkbook register 1, a wireless remote banking server 51, a wired remote banking server 52, a laptop personal computer 53, and a desktop personal computer 54. The electronic checkbook register 1 may comprise a processor 50, a wired communication module 55, a wireless communication module 56, a display 57, a memory module 60, and inputs 61. The electronic checkbook register 1 may comprise any of the embodiments discussed above. The inputs 61 and display 57 may comprise any of the inputs and displays discussed herein. The wireless communication module 56 may comprise the built-in antenna shown in FIG. 1, or any other type of wireless communication system well-known in the art. The memory module 61 may comprise the memory card 25 shown in FIG. 5, or any other type of memory device or system, including flash ROM and/or a memory card 25 coupled with flash ROM.

The electronic checkbook register 1 can communicate with remote banking servers 51, 52 and personal computers 53, 54 in order to synchronize (i.e., update) the information stored at the register 1 with user financial information stored at the remote computers 51-54, such as the user's actual bank account information or information associated with a user's personal financial manager (PFM) software such as Quicken® 2003 or Microsoft® Money 2003. Alternately, or in addition, the register 1 may transmit user financial information to a user's PFM in order to update the PFM. The electronic checkbook register 1 can also automatically set up a user's PFM tool(s) and load the appropriate accounts and transactions onto the PFM. Preferably, the electronic checkbook register 1 would perform such a setup process the first time a user attempted to interface the register's 1 information with the user's PFM. This would enable first-time PFM users to set up their PFM tools for one or more accounts with a minimum of user inputs. Various wireless protocols could be used for wireless communication between the register 1 and the remote computers, such as banking servers 51, 52 and personal computers 53, 54. Just by way of example, well-known protocols such as WAP, SMS, and Bluetooth could be employed. As shown in FIG. 5, an infra-red port 28 may also allow for wireless infra-red communication.

As shown in FIG. 10, data can be inputted at inputs 61, which may comprise any of the aforementioned inputs of the invention, such as the inputs that capture data from the checks 4. Data from the inputs is passed to the processor 50, which processes the data. Processing data can comprise processing the image of the check and passing the image to the display 57. If the processor is enabled with handwriting recognition technology, the processor can convert the handwriting and other information on the check into alphanumeric symbols representing the check information. The processor can then pass the converted alphanumeric symbols to the display 57 for viewing by the user. The user can edit the displayed information by entering the appropriate new information at the inputs 61 or the display 57, if the display is a touch-sensitive display 2A.

The processor may also calculate the current balance, available balance, and the balance after pending transactions have cleared. To store data, the processor may pass data to the memory module 60, which can include the memory card 25 as well as flash memory and other memory. Stored information can be passed from the memory module 60 to the processor 50 whenever needed by the processor 50.

The processor 50 can pass information to, and receive information from, a wired communication module 55 and a wireless communication module 56 in order to communicate with remote computers 51-54 via wire connection or wireless connection, respectively. The wired communication module 55 can include ports and associated wires and apparatus to effect communication with another computer via wire connection. The wireless communication module can include the built-in antenna 19 for transmitting and receiving information over a wireless communications network with remote computers 51-54. The remote computers can include desktop 54 and laptop 53 personal computers as well as wired 52 and wireless 51 remote banking servers. The remote computers can also include any other kind of computer or processing device.

The communication modules 55, 56 can transmit information to the remote computers 51-54, including password, PIN, or other authentication information. In a preferred embodiment, the communication modules must supply a PIN to the remote banking computer 51, 52 before financial data can be exchanged. The PIN, password, or other authentication information can be stored in the memory module 60, and the processor can retrieve such information and pass it to the communication module 55, 56 automatically at the beginning of each communication session.

Upon proper authentication, the remote banking servers 52 will then transmit financial information to the communication module 55, 56, which is then passed to the processor 50 and can then be stored in the memory module 60. The financial information can include any financial transaction, including recent transactions on a user's account, such as ATM transactions, debit card transactions, the clearing of a check, the clearing of a deposit, allowance, or paycheck, and any other activity on a user's account. This information can be displayed on the display 57 so that users can see account information such as the amount of funds available for future transactions. The transmitted account information can be for a savings account, a checking account, a credit card account, a stored value card account, a debit account, or from a plurality of the aforementioned accounts.

The register 1 can also transmit financial information to the remote computers 51-54. For instance, information relating to recent checks written and stored at the register 1 can be passed from the memory module 60 to the processor 50 to a communication module 55, 56, and then to a remote computer 51-54. The remote computer 51-54, such as a personal computer 53, 54 that uses a personal financial manager to organize a user's finances, can thereby access recent checking transactions from the register 1 to update the computer's financial records.

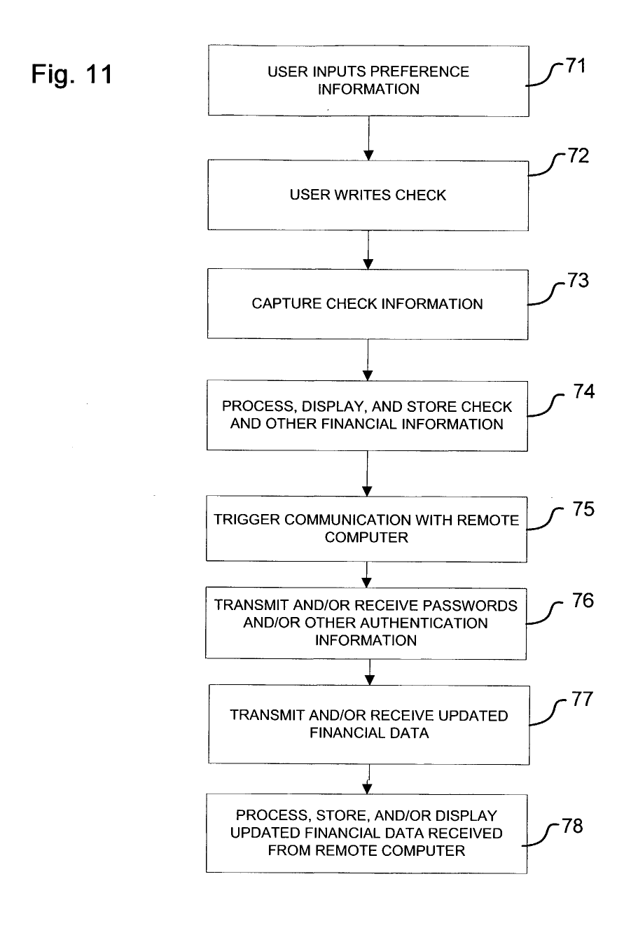

FIG. 11 is a flow chart of a method for managing account information according to yet another embodiment of the invention. First, the user inputs preference information 71. Preference information can include the user's preferences concerning the formatting and layout of display information, such as the fields to be displayed, the ordering of the fields, the color and size of the fields and characters, default prompts, etc. The options for configuring a display layout are well-known in the art. The user can also input security preferences concerning what types of information or information fields are available at any time, which information is available only after input of a password, which information can be downloaded from a bank and/or displayed with or without first entering a password, and other preferences relating to accessing information stored at or retrieved by the register 1. The user can also input preferences concerning the frequency and type of communication with a remote server, such as how often the register 1 polls a remote computer for updates (register 1 can poll for updates automatically and/or based on user-initiated polling). Such preferences can include a preference for receiving updates whenever a new transaction posts at a bank and/or a preference for receiving updates at specific times or time intervals. The preferences are processed by the processor 50 and stored in the memory module 60. The preferences regarding updates can also be stored at the remote banking server 51, 52 of FIG. 10.

Then the user writes a check 72. In a preferred embodiment, the user uses a writing utensil such as the pen 8 to fill in the fields of a check 4 while it is resting against the touch-sensitive pad 5, as discussed in relation to FIG. 1. Then the register 1 captures the check information through any of the methods described above, including the use of the touch-sensitive pad 5, the pen detector 7, and/or an optical reader 6. In step 74, the check and other financial information is then processed at the processor 50, displayed at the display 57, and stored at the memory module 60, using any of the methods described above.

In step 75, communication with a remote computer is triggered. This can happen any of several ways, depending on the user's preference information entered at step 71. For instance, if the user inputted a preference for obtaining updated information from a remote banking server 51, 52 every six hours, then the lapse of six hours will trigger the register 1 to poll the remote banking server. Such updates can also be triggered whenever the user touches the hot synch button 14 or otherwise requests the register 1 to obtain an input. A bank, preferably by way of a remote banking computer 51, 52 can also trigger communication by notifying the register 1 that a new transaction has posted to the user's account, or by otherwise requesting communication with the register 1. It will be appreciated that certain preferences may be adapted, e.g., a six-hour polling cycle may not occur at exactly the sixth hour if the register 1 is powered off at that time, and instead the next polling may take place immediately after the register 1 is next powered on.

In step 76, the register 1 and the remote computer 51-54 communicate with each other, as described above. In a preferred embodiment, the register 1 transmits a password to enable access to the user's account information at a remote banking server 51-52. The data exchanged between the register 1 and the remote computer(s) 51-54 can be encrypted before transmitting and decrypted after receiving in order to ensure secure communication of data. Also, the exchanged data can be transmitted and received on a real-time or a batch basis in accordance with any standard or proprietary format, including XML, OFX, QFX, and comma-delimited text.

After receiving and verifying the password, in step 77, the remote banking server 51, 52 transmits account information to the register 1. This account information may include all the account activity that has occurred since the last time the register 1 downloaded information from a remote banking server 51, 52.

Finally, in step 78, the processor processes the new updated information and stores it at the memory module 60, and then the information can be passed to the display 57, which can display the information.

It should be noted that the methods described above can be altered to accord with a given situation. For instance, if the register 1 communicates with a remote server while the register 1 is in the closed position, the updated information may not be displayed at that time.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

What is claimed is:

1. An electronic checkbook register, comprising:
a checkbook comprising one or more checks;
an electronic display device operatively coupled to the checkbook;
a user input device for capturing written user input; and
a processor operatively connected to the display device and the user input device, the processor adapted to:
receive financial data input by a user to the user input device;
process the financial data; and
output the processed financial data to the display device.

2. The electronic checkbook register of claim 1, further comprising a card sleeve for storing one or more financial cards.

3. The electronic checkbook register of claim 1, wherein the processor is further adapted to synchronize the financial data with a personal financial manager (PFM) tool.

4. The electronic checkbook register of claim 3, wherein the processor is further adapted to automatically set up a personal financial manager (PFM) tool so that the personal financial manager (PFM) tool can accept, process, and organize account and transaction information received from the electronic checkbook register.

5. The electronic checkbook register of claim 1, wherein the user input device is configured to capture check information entered by the user on a check and pass the captured information to the processor, and wherein the user input device comprises at least one of:
a pressure-sensitive device;
an optical reader;
a pen device comprising a writing tip and at least one detector; and
a means for manually key-entering the check information.

6. The electronic checkbook register of claim 1, further comprising a memory operatively connected to the processor, wherein the processor processes the captured check information and stores the resulting processed information in the memory.

7. The electronic checkbook register of claim 1, wherein the processor is further adapted to perform handwriting recognition to convert said captured information into alphanumeric symbols corresponding to the check information entered by the user.

8. The electronic checkbook register of claim 1, further comprising a writing utensil, wherein said user input device comprises a pressure-sensitive pad coupled to said one or more checks, and wherein said pad is configured to:
detect pressure of the writing utensil when the writing utensil exerts pressure against one or more checks flush against the pad;
generate check information based on detecting the pressure; and
pass the generated check information to the processor.

9. The electronic checkbook register of claim 8, further comprising a memory operatively connected to the processor, wherein the processor stores the generated check information in the memory.

10. The electronic checkbook register of claim 8, wherein the processor is programmed to convert said generated check information into alphanumeric symbols representing the check information.

11. The electronic checkbook register of claim 1, further comprising:
a second electronic display on an outside cover of the electronic checkbook register.

12. The electronic checkbook register of claim 1, wherein said second electronic display is configured to display at least one of the current time, the current date, the user's name, and the user's nickname.

13. The electronic checkbook register of claim 1, wherein said financial data input comprises a payee and an amount of money.

14. The electronic checkbook register of claim 1, wherein processing the financial data comprises calculating at least one of a current balance, an available balance, and a balance after all pending checks have cleared.

15. The electronic checkbook register of claim 1, wherein the processor is further adapted to synchronize the financial data with account information stored at a remote banking computer.

16. The electronic checkbook register of claim 15, wherein the processor is adapted to synchronize by:
receiving account information from the remote banking computer;
processing the account information; and
updating the processed financial data based on the processed account information.

17. The electronic checkbook register of claim 16, further comprising at least one of a wireless transmitter and wireless receiver for wireless communication with the remote banking computer.

18. The electronic checkbook register of claim 16, wherein the wireless communication uses at least one of Bluetooth, SMS, WiFi, and WAP protocol.

19. The electronic checkbook register of claim 16 further comprising at least one port for communicating with a remote banking computer.

20. The electronic checkbook register of claim 16, wherein said at least one port is at least one of a USB port, a firewire port, a serial port, a parallel port, and an infra-red port.

21. The electronic checkbook register of claim 1, wherein the display is configured to have a screen saver mode for limiting power consumption, and wherein the screen saver mode is configured to display marketing information.

22. A system for managing an electronic checkbook register and one or more deposit accounts, comprising:
an electronic checkbook register comprising a processor operatively connected to:
a checkbook;
one or more displays;
one or more input devices for receiving check information from a user; and
a first memory storing first account information;
a remote computer comprising a second memory storing second account information; and
a communications network between the electronic checkbook register and the remote computer for transmitting at least one of:
the first account information from the electronic checkbook register to the remote computer; and
the second account information from the remote computer to the electronic checkbook register.

23. The system of claim 22, wherein the communications network is a wireless network.

24. The system of claim 22, wherein the communications network is a wired network.

25. The system of claim 22, wherein the first account information is transmitted from the electronic checkbook register to the remote computer, the second memory of the remote computer storing the second account information, and the remote computer further comprises a second processor configured to process the first account information and generate third account information based on the first account information and the second account information.

26. The system of claim 22, wherein the first account information is check information, the second account information is bank account information, and the third account information is updated check information.

27. The system of claim 26, wherein the third account information is displayed at the one or more displays.

28. The system of claim 22, wherein the second account information is transmitted from the remote computer to the electronic checkbook register processor, and the electronic checkbook register processor is adapted to process the first account information and generate third account information based on the first account information and the second account information.

29. A method for processing user financial information comprising:
receiving user input from one or more input devices operatively connected to a processor, wherein said user input comprises user writing including at least one of a payee and an amount of money on a check operatively connected to a processor and one or more display devices;
processing said user input;
calculating user-specific financial information based on said input, said user-specific financial information comprising at least one of a current balance, an available balance, and a balance after pending deposit account transactions have cleared; and
storing the user-specific financial information in a memory operatively connected to the processor.

30. The method of claim 29, said method further comprising:
receiving updated account information from a remote banking computer; and
processing the updated account information.

31. The method of claim 29, said method further comprising:
configuring a personal financial manager (PFM) tool to accept, process, and organize information stored in the memory.

32. The method of claim 29, said method further comprising:
receiving security preferences from the user at one or more of the user inputs;
transmitting an internal password to a remote banking computer;
receiving encrypted updated account information from the remote banking computer in accordance with the security preferences;
decrypting the updated account information; and
processing the updated account information.

33. The method of claim 32, wherein the remote banking computer is one of a personal desktop computer, a personal laptop computer, a remote banking server, or a computer belonging to a third party.

34. The method of claim 32, wherein the security preferences provide for:
storing the updated account information from the remote banking computer in a memory operatively connected to the processor;
preventing the updated account information from altering the user-specific financial information until the user enters a PIN at an input device operatively connected to the processor;
upon the user entering the PIN, processing the updated account information and updating the user-specific financial information with the updated account information.

35. The method of claim 32, said method further comprising:
receiving transaction field selections from a user, wherein the field selections govern which fields can be transmitted from a remote banking computer to the electronic checkbook register, and wherein the security preferences comprise requiring the remote banking computer to receive a password or PIN transmission from the electronic checkbook register before the remote banking computer can transmit the user-selected transaction fields to the electronic checkbook register.

36. The method of claim 32, said method further comprising:
at the request of the user, initiating a request by the electronic checkbook for the remote banking computer to transmit any updated account information;
authenticating the internal password of the electronic checkbook register by the remote banking computer; and
transmitting encrypted updated account information by the remote banking computer to the electronic checkbook register.

37. The method of claim 29, said method further comprising:
receiving a polling preference from the user at one or more input devices; and
polling at least one remote banking computer at specific time intervals in accordance with the user's polling preference, said polling causing the one or more remote banking computers to check if any new transactions have posted to the account since the most recent polling.

38. The method of claim 30, said method further comprising:
receiving an updating preference from the user at one or more input devices; and
receiving encrypted updated account information from the remote banking computer in accordance with the updating preference.

39. The method of claim 38, wherein said updating preference is a preference for one of the following:
an automatic update, wherein updated account information is transmitted to the electronic checkbook register from the remote banking computer immediately after a new transaction record becomes available at the remote banking computer, and wherein any new transaction record is automatically accepted at the electronic checkbook register;
a PIN-based update, wherein the user must enter a PIN before any updated account information can be transmitted to the electronic checkbook register; and
a manual update, wherein the remote banking computer sends updated account information whenever the user chooses to contact the computer, and wherein the user must select to accept, reject, or reconcile any new transactions received with the updated account information.

40. The method of claim 30, wherein the updated account information is transmitted and received on one of a real-time and batch basis in accordance with at least one of XML, OFX, QFX, comma-delimited text, and any standard or proprietary format.

41. The method of claim 29, said method further comprising:
receiving account information from a remote computer;
processing the account information; and
passing the processed account information to an output device.

42. The method of claim 41, said method further comprising:
receiving one or more display preferences from the user at the one or more input devices, wherein the display preferences determine which fields will be displayed and/or how they will be displayed at the one or more display devices; and
processing the display preference,
wherein said step of passing said financial information to an output device is based on the display preference.

43. The method of claim 41, said method further comprising
receiving display preferences from the user at one or more of the user inputs, wherein the display preferences comprise a preference for one or more specific types of financial information to be displayed on a display device operatively connected to the processor;
generating at least one display output in accordance with the display preferences; and
passing the financial information to a remote computer.

44. The method of claim 29, said method further comprising:
receiving user preference information regarding displaying information on a display device operatively connected to the processor; and
displaying user financial information based on the display preference information.

45. The method of claim 29, wherein said security preferences comprise whether the user elects to require a PIN input to enable the display of specific fields of financial information at the display device.

46. A computer-readable medium encoded with computer program code to manage an electronic checkbook register, the program code effective to perform the following:
receiving user input from one or more input devices operatively connected to a processor, wherein said user input comprises user writing including at least one of a payee and an amount of money on a check operatively connected to a processor and one or more display devices;
processing said user input;
calculating user-specific financial information based on said input, said user-specific financial information comprising at least one of a current balance, an available balance, and a balance after pending deposit account transactions have cleared; and
storing the user-specific financial information in a memory operatively connected to the processor.

47. The computer-readable medium of claim 46, the program code further effective to perform the following:
receiving security preferences from the user at one or more of the user inputs;
transmitting an internal password to a remote banking computer;
receiving encrypted updated account information from the remote banking computer in accordance with the security preferences;
decrypting the updated account information; and
processing the updated account information.

48. The computer-readable medium of claim 47, wherein the security preferences provide for:
storing the updated account information from the remote banking computer in a memory operatively connected to the processor;
preventing the updated account information from altering the user-specific financial information until the user enters a PIN at an input device operatively connected to the processor;
upon the user entering the PIN, processing the updated account information and updating the user-specific financial information with the updated account information.

49. The computer-readable medium of claim 47, the program code further effective to perform the following:
receiving transaction field selections from a user, wherein the field selections govern which fields can be transmitted from a remote banking computer to the electronic checkbook register, and wherein the security preferences comprise requiring the remote banking computer to receive a password or PIN transmission from the electronic checkbook register before the remote banking computer can transmit the user-selected transaction fields to the electronic checkbook register.

50. The computer-readable medium of claim 46, the program code further effective to perform the following:
receiving a polling preference from the user at one or more input devices; and
polling at least one remote banking computer at specific time intervals in accordance with the user's polling preference, said polling causing the one or more remote banking computers to check if any new transactions have posted to the account since the most recent polling.

51. The computer-readable medium of claim 46, the program code further effective to perform the following:
at the request of the user, initiating a request by the electronic checkbook for the remote banking computer to transmit any updated account information;
authenticating the internal password of the electronic checkbook register by the remote banking computer; and
transmitting encrypted updated account information by the remote banking computer to the electronic checkbook register.

52. The computer-readable medium of claim 46, the program code further effective to perform the following:
receiving an updating preference from the user at one or more input devices; and
receiving encrypted updated account information from the remote banking computer in accordance with the updating preference.

53. The computer-readable medium of claim 52, wherein said updating preference is a preference for one of the following:
an automatic update, wherein updated account information is transmitted to the electronic checkbook register from the remote banking computer immediately after a new transaction record becomes available at the remote banking computer, and wherein any new transaction record is automatically accepted at the electronic checkbook register;
a PIN-based update, wherein the user must enter a PIN before any updated account information can be transmitted to the electronic checkbook register; and
a manual update, wherein the remote banking computer sends updated account information whenever the user chooses to contact the computer, and wherein the user must select to accept, reject, or reconcile any new transactions received with the updated account information.

54. The computer-readable medium of claim 46, the program code further effective to perform the following:
receiving account information from a remote computer;
processing the account information; and
passing the processed account information to an output device.

55. The computer-readable medium of claim 46, the program code further effective to perform the following:
receiving user preference information regarding displaying information on a display device operatively connected to the processor; and
displaying user financial information based on the display preference information.

56. The computer-readable medium of claim 47, wherein said security preferences comprise whether the user elects to require a PIN input to enable the display of specific fields of financial information at the display device.
